(19) United States
(12) Patent Application Publication
(10) Pub. No.: US 2016/0210379 A1
(43) Pub. Date: Jul. 21, 2016

(54) ALIGNING EVENT DATA WITH A HIERARCHICAL DECLARATIVE PROCESS MODEL

(71) Applicant: International Business Machines Corporation, Armonk, NY (US)

(72) Inventors: Geetika T. Lakshmanan, Winchester, MA (US); Xiang Li, Beijing (CN); Haifeng Liu, Beijing (CN); Guo T. Xie, Xi Er Qi (CN)

(21) Appl. No.: 14/601,515

(22) Filed: Jan. 21, 2015

(51) Int. Cl. G06F 17/50; G06F 17/18

(52) U.S. Cl. CPC G06F 17/5009; G06F 17/18

(57) ABSTRACT

In an approach to aligning an event trace data with a hierarchical declarative process model, a computer processor retrieves an event trace data containing at least one activity and a hierarchical declarative process model, wherein the hierarchical declarative process model includes at least one hierarchical level that represents a phase. The computer processor determines at least one phase for each of the at least one activity of the event trace data. The computer processor creates a phase tree for each of the at least one phase. The computer processors aligns the phase tree for each of the at least one phase with each phase of the hierarchical declarative process model.

### BACKGROUND OF THE INVENTION

The present invention relates generally to the field of data processing and modeling, and more particularly to aligning event data with a hierarchical declarative process model.

In many unstructured environments such as healthcare and case management, where events can occur in many different sequences or orders, the number of events and their diversity is large. A hierarchical declarative process model, or a care pathway model, provides a knowledge-centric process to guide clinicians to provide evidence-based care to patients with specific conditions. A care pathway is one of the main tools used to manage quality in healthcare concerning standardization of care processes. Care pathways, also known as clinical pathways, promote organized and efficient patient care based on evidence based practice, and consists of multiple phases corresponding to different therapies where each phase can have care activities performed by clinicians.

### SUMMARY OF THE INVENTION

Embodiments of the present invention disclose a method for aligning an event trace data with a hierarchical declarative process model. The method may include a computer processor retrieving an event trace data containing at least one activity and retrieving a hierarchical declarative process model, wherein the hierarchical declarative process model includes at least one hierarchical level that represents a phase. The computer processor determines at least one phase for each of the at least one activity of the event trace data and creates a phase tree for each of the at least one phase. The computer processor aligns the phase tree for each of the at least one phase with each phase of the hierarchical declarative process model.

Embodiments of the present invention disclose a computer program product for aligning an event trace data with a hierarchical declarative process model, the computer program product comprising a computer readable storage medium having program instructions embodied therewith, the program instructions executable by a computer processor to cause the computer processor to perform a method comprising retrieving, by the computer processor, an event trace data containing at least one activity and a hierarchical declarative process model, wherein the hierarchical declarative process model includes at least one hierarchical level that represents a phase. The method includes determining, by the computer processor, at least one phase for each of the at least one activity of the event trace data and creating a phase tree for each of the at least one phase. The method includes aligning, by the computer processor, the phase tree for each of the at least one phase with each phase of the hierarchical declarative process model.

Embodiments of the present invention disclose a computer system for aligning an event trace data with a hierarchical declarative process model, the computer system comprising one or more computer processors, one or more computer readable storage media, and program instructions stored on the one or more computer readable storage media for execution by at least one of the one or more computer processors. The program instructions comprise program instructions to retrieve an event trace data containing at least one activity and a hierarchical declarative process model, wherein the hierarchical declarative process model includes at least one hierarchical level that represents a phase. The program instructions also comprise program instructions to determine at least one phase for each of the at least one activity of the event trace data and program instructions to create a phase tree for each of the at least one phase. The program instructions comprise program instructions to align the phase tree for each of the at least one phase with each phase of the hierarchical declarative process model.

### BRIEF DESCRIPTION OF THE DRAWINGS

FIG. 1 is a functional block diagram illustrating a data processing environment, in accordance with an embodiment of the present invention;

FIG. 2 is a flowchart depicting operational steps of an event aligning program, for retrieving event trace data and a hierarchical declarative process model, and aligning the data to the hierarchical declarative process model, in accordance with an embodiment of the present invention;

FIG. 3A depicts a flow diagram of steps to create one or more phase trees containing events gathered from the event trace data, in accordance with an embodiment of the present invention;

FIG. 3B depicts an aligned event trace created according to the operational steps in FIG. 2 and the steps in FIG. 3A, in accordance with an embodiment of the present invention;

FIG. 4 is a block diagram of an example of a cloud computing node, in accordance with an embodiment of the present invention;

FIG. 5 depicts an illustrative cloud computing environment, in accordance with an embodiment of the present invention; and

FIG. 6 depicts a set of functional abstraction layers provided by a cloud computing environment, in accordance with an embodiment of the present invention.

### DETAILED DESCRIPTION OF THE PREFERRED EMBODIMENTS

A care pathway is an intervention for the mutual decision-making and organization of care processes for a well-defined group of patients during a well-defined period. Relying on care pathways, clinicians can create care plans for individual patients with specific clinical conditions in order to improve care quality. The execution of a pathway has the following characteristics: 1) there can be temporal order constraints associated with two activities or phases; 2) the same care activity can be executed in different phases; 3) different phases can be executed in parallel; and 4) different activities can be executed at the same time.

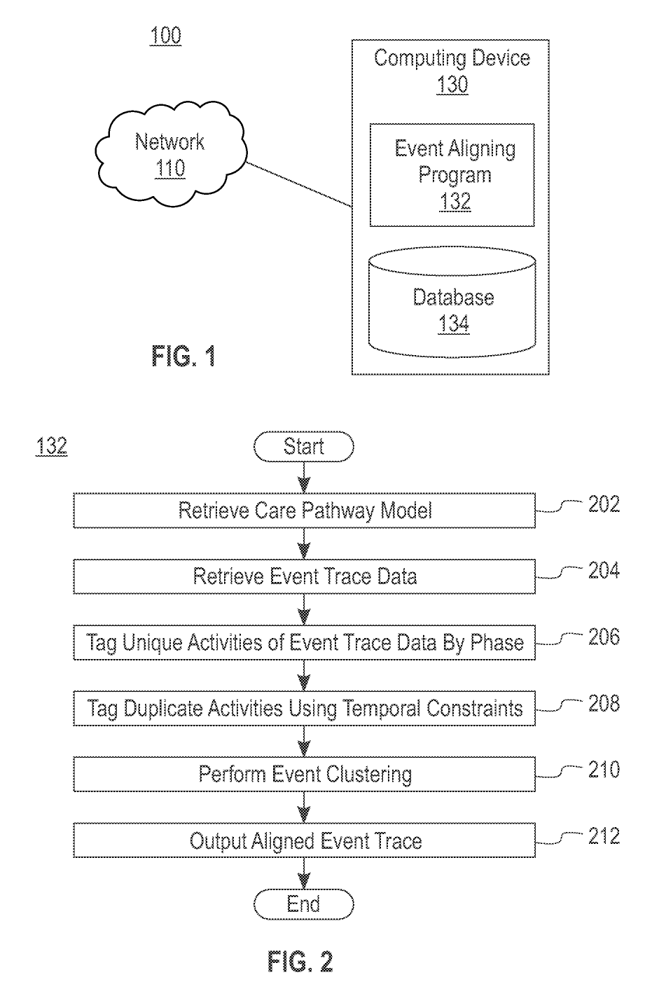

The present invention will now be described in detail with reference to the Figures. FIG. 1 is a functional block diagram illustrating a data processing environment, generally designated 100, in accordance with one embodiment of the present invention. In an exemplary embodiment, data processing environment 100 represents a healthcare environment. In various other embodiments, data processing environment 100 may represent a case management environment. FIG. 1 provides only an illustration of one implementation and does not imply any limitations with regard to the environments in which different embodiments may be made by those skilled in the art without departing from the scope of the invention as recited by the claims.

Data processing environment 100 includes computing device 130 connected to network 110. Network 110 can be, for example, a telecommunications network, a local area network (LAN), a wide area network (WAN), such as the Internet, or a combination of the three, and can include wired, wireless, or fiber optic connections. Network 110 may include one or more wired and/or wireless networks that are capable of receiving and transmitting data, voice, and/or video signals, including multimedia signals. In general, network 110 can be any combination of connections and protocols that will support communications between computing device 130 and other devices within data processing environment 100 (not shown).

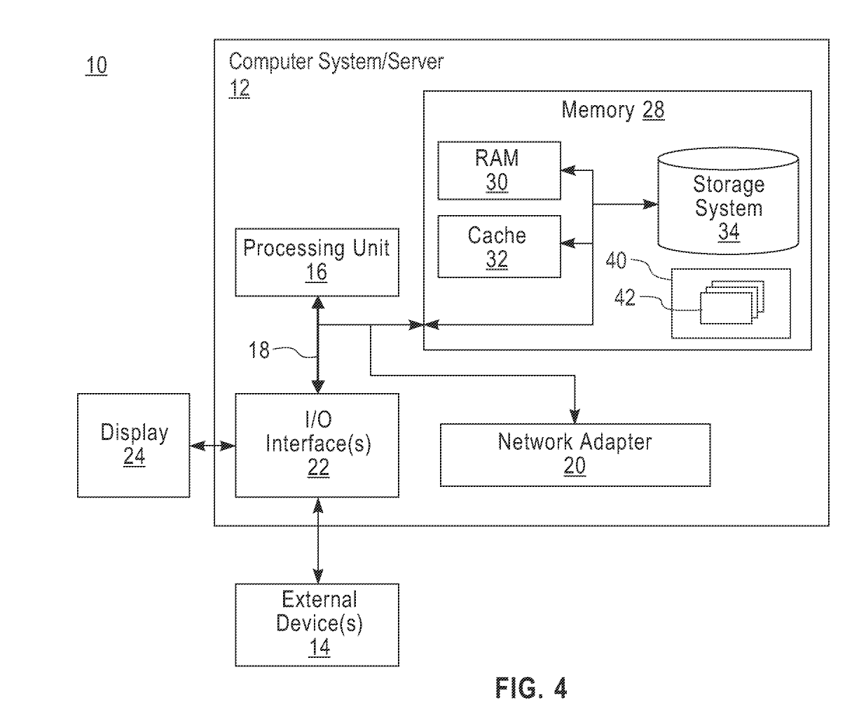

In various embodiments, computing device 130 can be a standalone computing device, management server, a web server, a mobile computing device, or any other electronic device or computing system capable of receiving, sending, and processing data. In other embodiments, computing device 130 can represent a server computing system utilizing multiple computers as a server system. In another embodiment, computing device 130 can be a laptop computer, a tablet computer, a netbook computer, a personal computer, a desktop computer, or any programmable electronic device capable of communicating with other computing devices (not shown) within data processing environment 100 via network 110. In another embodiment, computing device 130 represents a computing system utilizing clustered computers and components (e.g., database server computers, application server computers, etc.) that act as a single pool of seamless resources when accessed within data processing environment 100. In various embodiments, each of the program and database including on computing device 130 may be located elsewhere within data processing environment 100 with access between each other via network 110. Computing device 130 may include internal and external hardware components, as depicted and described with reference to FIG. 4. Computing device 130 includes event aligning program 132 and database 134.

Event aligning program 132 retrieves a care pathway model and event trace data for a patient within data processing environment 100. The care pathway model outlines a decision-making process for the patient's condition or diagnosis, and the event trace data is specific for the patient, containing information on events that have occurred during the patient's care and a timestamp at which the event occurred. In a care pathway, multiple events may occur in the same phase of care, but at different times, or at the same time, but in different phases. Event aligning program 132 tags the data by phase, and performs an event clustering algorithm on the data to cluster each event by its associated phase, create a phase tree for each event class, and assign events to the phase tree by timestamp in order to align the event trace data with the care pathway model. Event aligning program 132 creates an output of an aligned event trace. In various embodiments of the present invention, event aligning program 132 may be applied to insurance case management data or to align raw events of any semi-structured business process which can be described in terms of a hierarchical declarative process model.

Database 134 stores event trace data and care pathway models for various conditions, diagnoses, and patients within data processing environment 100. While depicted in FIG. 1 as residing on computing device 130, in various other embodiments, database 134 can reside elsewhere within data processing environment 100. A database is an organized collection of data. Database 134 can be implemented with any type of storage device capable of storing data that can be accessed and utilized by computing device 130, such as a database server, a hard disk drive, or a flash memory. In other embodiments, database 134 can represent multiple storage devices within computing device 130.

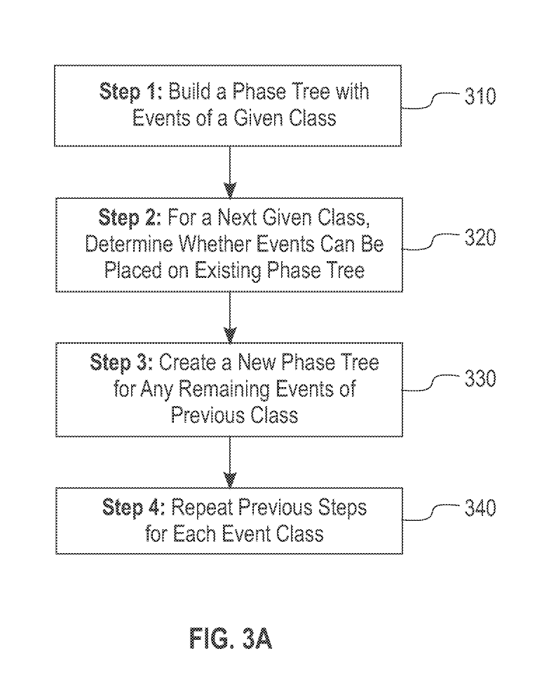

FIG. 2 is a flowchart depicting operational steps of event aligning program 132, for retrieving event data and a hierarchical declarative process model, and aligning the data to the hierarchical declarative process model, in accordance with an embodiment of the present invention.

Referring to FIG. 2, at step 202, event aligning program 132 retrieves a care pathway model. A care pathway model is a hierarchical declarative process model for creating care plans for individual patients with a specific clinical condition. In a declarative process model, all executions are allowed except those explicitly prohibited by the process model, such that the model provides constraints but except for those constraints, the process can be executed in any order. Care pathway models are developed within a healthcare management system, particularly aimed at improving patient healthcare. Within the healthcare management system, a care pathway model may contain guidelines and procedures created and stored by doctors, administrators, or others with an interest in improving patient healthcare. A care pathway model as a hierarchical declarative process model indicates that each level of the hierarchy is a different phase of care. During each phase, certain activities or events must occur, sometimes with a temporal constraint, but one or more duplicate activities, associated with different phases, may also occur and therefore multiple phases may occur concurrently. In the exemplary embodiment, at least one care pathway model is stored in database 134 for use by event aligning program 132. In another embodiment, a care pathway model may reside on a second computing device (not shown) within data processing environment 100 and may be retrieved by event aligning program 132 via network 110.

At step 204, event aligning program 132 retrieves event trace data. Event trace data contains, for example, a sequence of clinical events occurring for a specific patient. An event corresponds to an occurrence of a clinical activity for the patient, and each event has an associated timestamp, typically a date, but the timestamp may also be a minute or hour on a date. In an event trace, there may be additional activities that are not covered by the care pathway. For example, a patient's weight may be taken at intake, but the weight is not a factor or event considered by the care pathway model for the patient's condition. Event aligning program 132 retrieves raw event data from, for example, a patient's medical record, or other electronic records stored in database 134 or retrievable via network 110 within data processing environment 100.

At step 206, event aligning program 132 tags unique activities of event trace data by phase. Event aligning program 132 tags the events that can be mapped to unique activities. An event in a trace is an instance of an activity. In the care pathway, this activity is defined under a phase. If the activity is unique (i.e., the activity is defined only once in one phase), then there is a direct mapping between the event and the phase. For example, if a care pathway has two phases, ‘P1’ and ‘P2’, and three activities, (A), (B), and (C). The first phase, P1, contains (A) and (B), and P2 contains (B) and (C), then (A) and (C) are unique activities. An event of (A) in a trace will be directly mapped to phase P1. In order to determine where the care pathway model and the event trace data deviate from one another, each event in the event trace data is tagged with a phase.

At step 208, event aligning program 132 tags duplicate activities using temporal constraints. Event aligning program 132 tags the events that can be mapped onto duplicate activities using temporal constraints. For example, an event (B) occurring at a time, T1 occurs during Phase P1, however, the event (B) occurring at time, T2 occurs during Phase P2. Temporal constraints may also be represented by phase rules, which can specify a precedence relationship between events or activities, such as “in Phase P1, if (A) occurs, (B) must occur afterwards,” or “in Phase P2, if (C) occurs, (B) must have occurred before.” Event aligning program 132 identifies events that belong to the same phase, while maintaining consideration of the time proximity of events. For example, two events that occur considerably far apart on a care timeline will not accidentally be tagged to the same phase even if the event satisfy a phase rule.

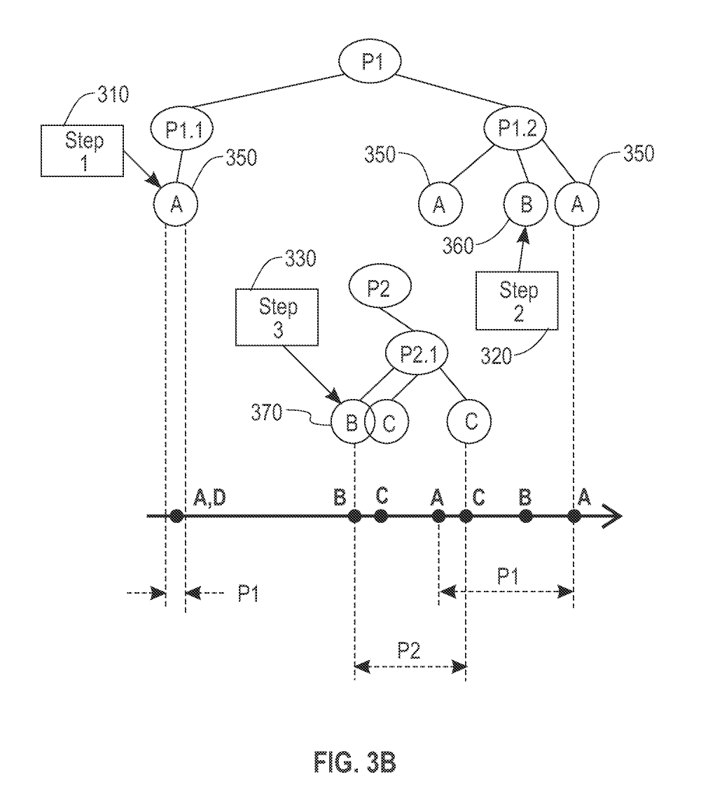

At step 210, event aligning program 132 performs event clustering. Event aligning program 132 clusters events to phase instances using a tree-based incremental clustering algorithm, as depicted and discussed with reference to FIGS. 3A and 3B. For every phase in the care pathway model, event aligning program 132 forms a tree with events as leaves and phase instances on the next higher level. A distance function can be defined using the timestamps of the events. Event aligning program 132 aligns events to phase instances by taking into account the time proximity of events, allowing multiple phases to execute in parallel. Event aligning program 132 normalizes the timestamps for each event and creates an event tree for each phase. Events can be split according to either a timestamp or a time duration from start. In various embodiments of the present invention, if an event timeline is dense, a midpoint root split may be appropriate. In another embodiment, if the event timeline is sparse, a root split point may be selected at the midpoint of the largest gap in the timeline.

At step 212, event aligning program 132 outputs an aligned event trace. An exemplary aligned event trace with a phase tree is depicted in FIG. 3B (discussed below). The aligned event trace depicts the event trace data aligned with the hierarchical declarative process model, where each level of the model represents a phase, and includes event data aligned with identified phase instances. In various embodiments of the present invention, the aligned event trace may be sent to a specific doctor or healthcare provider for the patient, or sent to an educational or administrative facility for analysis with respect to the condition or diagnosis that is the subject of the care pathway model. In another embodiment, the aligned event trace may be stored in database 134 for use and/or analysis at another time. In various embodiments of the present invention, the output of event aligning program 132 may be evaluated using drawbacks of Hidden Markov Model or Markov Random Field approaches. For example, evaluation of how many events executed on the same day are clustered to different phase instances, or how many event pairs with a long time interval are clustered to one phase instance. In an embodiment, the output can be used to detect deviation in a patient's care from a care pathway model.

FIG. 3A depicts a flow diagram of steps to create one or more phase trees containing events gathered from the event trace data, in accordance with an embodiment of the present invention.

At Step 1, denoted by 310 in FIG. 3A, a given class of events, (A), are added to leaf nodes on the tree according to time criteria. In an exemplary embodiment, the tree is a binary tree where each leaf node of the tree includes one or more phases associated with each other according to a timestamp and a determined timeline or duration of events. Event aligning program 132 determines a duration of events from start to finish in a specific patient's care. Event aligning program 132 determines a root split point for the duration. For example, the duration may be 105 days. The duration can be split at an approximate midpoint, into ‘0-53 days’ and ‘53-105 days’. Based on the timestamp of each event (A), the event is placed on the phase tree.

At Step 2, denoted by 320 in FIG. 3A, a next given class of events (B), is examined to determine whether any of the class falls onto a leaf node of an existing phase tree, either according to the event timestamp, or according to a phase rule. For example, in phase P1, (B) must follow (A). Any event (B) that falls onto the existing phase tree is placed accordingly.

At Step 3, denoted by 330 in FIG. 3A, a new phase tree is created with any remaining events of class (B), and at Step 4, 340 in FIG. 3A, the previous steps are repeated for each event class. In an embodiment, events not tagged with a phase are placed in the phase tree with leaves nearest the events timestamp, and the event then belongs to the phase to which the existing event belongs. For example, an event (D) occurring immediately after event (A) is placed on the phase tree next to (A), and (D) is then in phase P1.

FIG. 3B depicts an aligned event trace created according to the operational steps in FIG. 2 and the steps in FIG. 3A, in accordance with an embodiment of the present invention.

Step 1, 310 shown with arrow pointing to (A) 350, creates a phase tree for a first event class, here class (A) in phase (P1). Step 2, 320 shown with arrow pointing to (B) 360, adds a second event class, (B) to the existing phase tree where possible according to time stamp and phase rules. Step 3, 330 shown with arrow pointing to (B) 370, creates a new phase tree, here phase (P2), for those events of class (B) that cannot be added to an existing phase tree.

In an embodiment of the present invention, the phase P2 tree created in Step 3, 330 splits by duration based on the class (B) events. For example, the first (B) event starts at 90 days, and the last event that has not been placed in a phase tree, (C), starts at 97 days. In the example, (B) splits at four days so that (C) can be added to the phase tree. In various embodiments of the present invention, splitting can be done by time duration, or by absolute timestamp. In the previous example, if splitting is done by absolute timestamp, then the phase P2 root would split by “>90 days” and “<94 days”.

FIG. 4 is a block diagram of an example of a cloud computing node, in accordance with an embodiment of the present invention. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16. In an embodiment of the present invention, computer system/server 12 may be representative of computing device 130 in distributed data processing environment 100. In another embodiment, computing device 130 may include the hardware components of computer system/server 12 in a networked environment and not in a cloud computing environment.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

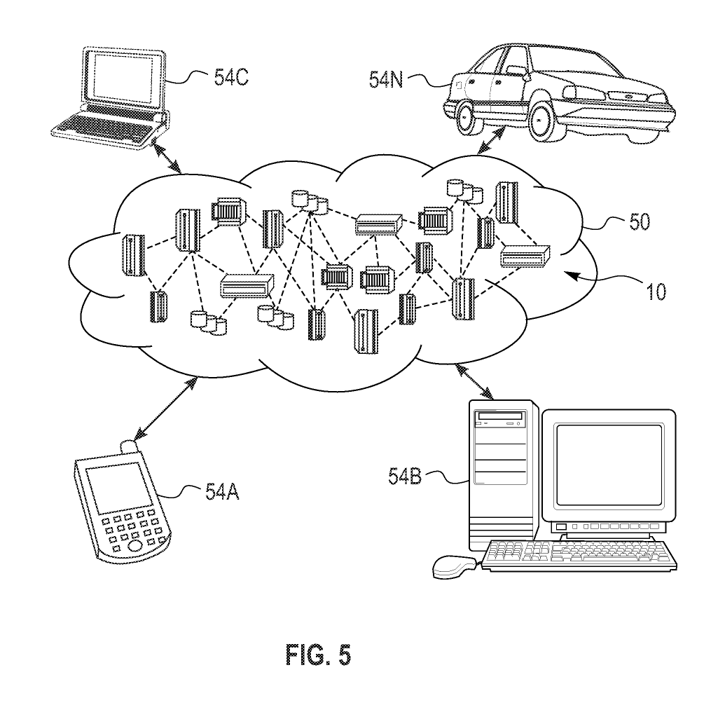

FIG. 5 depicts illustrative cloud computing environment 50, in accordance with an embodiment of the present invention. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

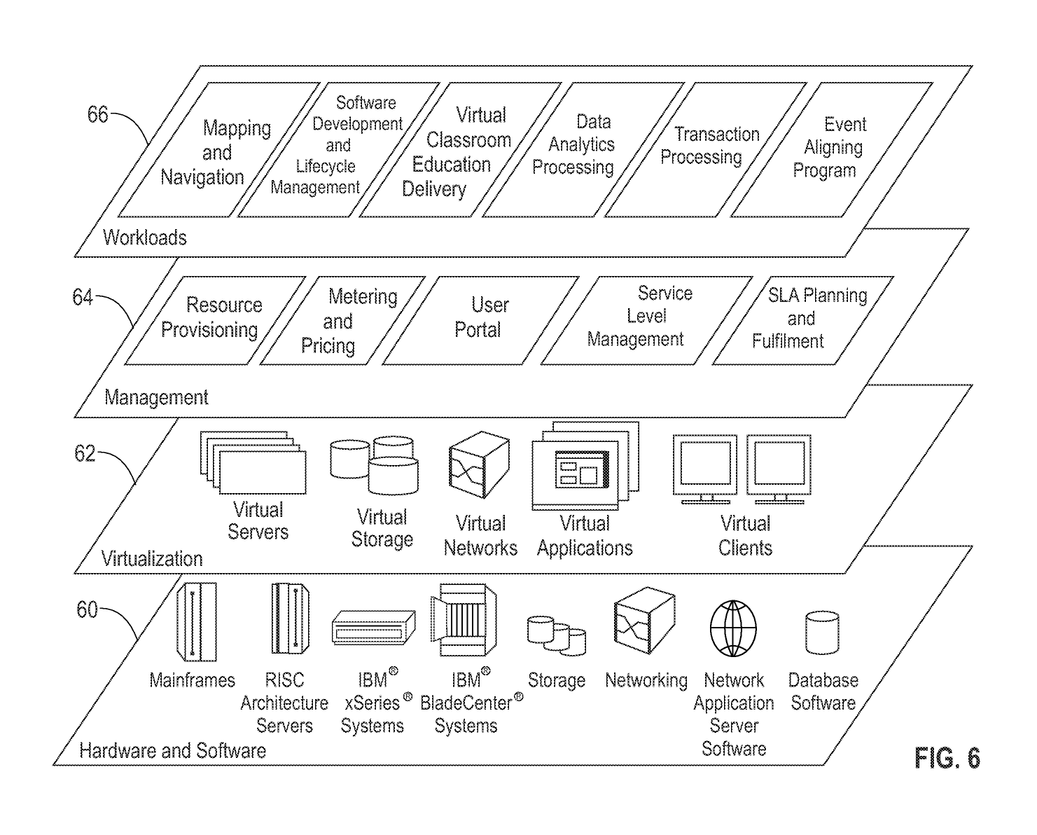

FIG. 6 depicts a set of functional abstraction layers provided by cloud computing environment 50, in accordance with an embodiment of the present invention. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include mainframes, RISC (Reduced Instruction Set Computer) architecture based servers, storage devices; networks and networking components. In some embodiments, software components include network application server software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and event aligning program.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for aligning an event trace data with a hierarchical declarative process model, the method comprising:
retrieving, by a computer processor, an event trace data containing at least one activity;
retrieving, by a computer processor, a hierarchical declarative process model, wherein the hierarchical declarative process model includes at least one hierarchical level that represents a phase;
determining, by a computer processor, at least one phase for each of the at least one activity of the event trace data;
creating, by a computer processor, a phase tree for each of the at least one phase; and
aligning, by a computer processor, the phase tree for each of the at least one phase with each phase of the hierarchical declarative process model.

2. The method of claim 1, further comprising:
determining, by a computer processor, based, at least in part, on a timestamp of each of the event trace data, one or more duplicate activities; and
determining, by a computer processor, at least one phase for each of the one or more duplicate activities.

3. The method of claim 1, wherein the event trace data includes a timestamp associated with each of the at least one activity.

4. The method of claim 1, wherein the event trace data contains a plurality of activities in which a first activity and a second activity are concurrent.

5. The method of claim 1, wherein the hierarchical declarative process model is a care pathway model.

6. The method of claim 1, wherein creating a phase tree for each of the at least one phase further comprises:
creating, by a computer processor, a binary tree, wherein each leaf node of the binary tree includes one or more phases associated with each other phase according to a timestamp associated with each of the at least one activity.

7. The method of claim 1, further comprising outputting the phase tree aligned with the hierarchical declarative process model.

8. The method of claim 1, wherein determining at least one phase for each of the at least one activity of the event trace data further comprises determining, by a computer processor, a phase rule, wherein the phase rule specifies a relationship between at least a first activity and a second activity of the event trace data.

9. A computer program product for aligning an event trace data with a hierarchical declarative process model, the computer program product comprising a computer readable storage medium having program instructions embodied therewith, the program instructions executable by a computer processor to cause the computer processor to perform a method comprising:
retrieving, by the computer processor, an event trace data containing at least one activity;
retrieving, by the computer processor, a hierarchical declarative process model, wherein the hierarchical declarative process model includes at least one hierarchical level that represents a phase;
determining, by the computer processor, at least one phase for each of the at least one activity of the event trace data;
creating, by the computer processor, a phase tree for each of the at least one phase; and
aligning, by the computer processor, the phase tree for each of the at least one phase with each phase of the hierarchical declarative process model.

10. The computer program product of claim 9, further comprising:
determining, by the computer processor, based, at least in part, on a timestamp of each of the event trace data, one or more duplicate activities; and
determining, by the computer processor, at least one phase for each of the one or more duplicate activities.

11. The computer program product of claim 9, wherein the event trace data includes a timestamp associated with each of the at least one activity.

12. The computer program product of claim 9, wherein the event trace data contains a plurality of activities, in which a first activity and a second activity are concurrent.

13. The computer program product of claim 9, wherein creating a phase tree for each of the at least one phase further comprises:
creating, by the computer processor, a binary tree, wherein each leaf node of the binary tree includes one or more phases associated with each other phase according to a timestamp associated with each of the at least one activity.

14. The computer program product of claim 9, wherein determining at least one phase for each of the at least one activity of the event trace data further comprises determining, by the computer processor, a phase rule, wherein the phase rule specifies a relationship between at least a first activity and a second activity of the event trace data.

15. A computer system for aligning an event trace data with a hierarchical declarative process model, the computer system comprising:
one or more computer processors;
one or more computer readable storage media;
program instructions stored on the one or more computer readable storage media for execution by at least one of the one or more computer processors, the program instructions comprising:
program instructions to retrieve an event trace data containing at least one activity;
program instructions to retrieve a hierarchical declarative process model, wherein the hierarchical declarative process model includes at least one hierarchical level that represents a phase;
program instructions to determine at least one phase for each of the at least one activity of the event trace data;
program instructions to create a phase tree for each of the at least one phase; and
program instructions to align the phase tree for each of the at least one phase with each phase of the hierarchical declarative process model.

16. The computer system of claim 15, further comprising:
program instructions to determine based, at least in part, on a timestamp of each of the event trace data, one or more duplicate activities; and
program instructions to determine at least one phase for each of the one or more duplicate activities.

17. The computer system of claim 15, wherein the event trace data includes a timestamp associated with each of the at least one activity.

18. The computer system of claim 15, wherein the event trace data contains a plurality of activities, in which a first activity and a second activity are concurrent.

19. The computer system of claim 15, wherein the program instructions to create a phase tree for each of the at least one phase further comprise:
program instructions to create a binary tree, wherein each leaf node of the binary tree includes one or more phases associated with each other phase according to a timestamp associated with each of the at least one activity.

20. The computer system of claim 15, wherein the program instructions to determine at least one phase for each of the at least one activity of the event trace data further comprise program instructions to determine a phase rule, wherein the phase rule specifies a relationship between at least a first activity and a second activity of the event trace data.
